(19) United States
(12) Patent Application Publication
(10) Pub. No.: US 2012/0052365 A1
(43) Pub. Date: Mar. 1, 2012

(54) ADVANCED HIGH DURABILITY LITHIUM-ION BATTERY

(76) Inventor: Chun-chieh Chang, Ithaca, NY (US)

(21) Appl. No.: 12/869,968

(22) Filed: Aug. 27, 2010

(51) Int. Cl. H01M 2/06; H01M 4/82

(52) U.S. Cl. 429/158; 429/179; 29/623.2

(57) ABSTRACT

A sealing system for a Lithium-ion battery to extend the service life of the battery. The sealing system provides, in addition to an external case of the battery, at least one additional layer of hermetic sealing for cells within the external battery case. Films of various plastics, provided in a single layer or in a combination of layers, are used for assembling hermetically sealed enclosures for the cells.

### FIELD OF THE INVENTION

The purpose of this invention is to make high durability Lithium-ion batteries that are adaptable to mass production, while maintaining high quality with tight sealing of the batteries. The structures and methods disclosed in the present invention are applicable to all Lithium-ion batteries.

### BACKGROUND

Sealing is always a key issue determining service life of Lithium-ion cells since high voltage of the cells render water decomposition or oxygen reduction if water or oxygen molecules are present in the electrolyte of the battery. The presence of water and oxygen can be caused by improper sealing of the battery. Conventionally, Lithium-ion cells are small in size and capacity. Taking “18650” cylindrical cells as an example, the cell size is 18 mm in diameter and 65 mm in height. The “18650” cylindrical cell capacity ranges from 2.8 Ah to 1.4 Ah etc. depending on the type of cathode materials being used for the cell. Owing to the limitation of space available between the lid and the external case of the battery, an interface in the area of the lid and the external case is usually small (only through an insulation layer which is typically shaped like an O-ring). Such interface does not provide a diffusion path of a sufficient length for absolutely preventing oxygen or water molecules from penetrating through the interface. The situation becomes worse when a continuous high temperature cycling condition is applied to the battery (e.g. conditions such as continuous high power operation) owing to the accelerated degradation of the interface. The condition is made worse with the presence of an electrolyte. The small molecules and the volatile nature of the electrolyte promotes penetration at the above mentioned interface, thus degrading the battery service life. The same problem is applicable to all types of Lithium-ion cells such as cylindrical cells, prismatic cells or even lithium polymer cells.

In order to overcome the aforementioned problem, a new structure of battery design is presently disclosed having new methods for constructing the battery. The electrodes, such as a jelly roll type for cylindrical cells, or electrode stacks for prismatic cells, are first enclosed in an initial enclosure of plastic (which can be shaped like a plastic bag) to provide hermetic sealing of the cell. A second hermetic sealing is then conducted using conventional sealing between the external case enclosing the cell(s) and its lid. With use of the initial enclosure, the amount of electrolyte present at the interface between the external case and the lid is drastically decreased, thus the battery is more durable in regard to gas and electrolyte molecule penetration. Even though the initial hermetic sealing may leak after some time, the electrolyte concentration close to the lid containing current collecting poles (with the presence of metal to polymer interface) is still small compared to if no initial hermetic seals are present. Further, the initial enclosure, shaped like a bag used for the first hermetic sealing can also limit the spill of electrolyte to the external case thus saving the amount of electrolyte necessary for filling up the entire external case, as done by conventional methods. It is note worthy that the hermetically sealed initial enclosure, which can be shaped like a bag to contain the jelly roll of a cylindrical cell or electrode stack of a prismatic cell can be just a plastic film or laminated plastic films that are electrolyte proof and there is no need to use laminated aluminum foils. That is, the cells do not need to be packed with the intention of working as a final or resultant battery. Another advantage of using the initial enclosure shaped like a plastic bag is for the prevention of shorting through the bag. The plastic bag of the initial enclosure described above, containing the jelly roll or electrode stack can be one or multiple plastic sheet layers depending on the need in service life of the battery. With the structure and method of the present invention being implemented in the battery, durable Lithium-ion cells possessing extended service life (targeted as 20 years) can be expected. A good sealing mechanism is very critical especially for large batteries (capacity more than 10 Ah) being utilized in large scale energy storage systems and/or high power applications such as electric vehicles and hybrid electric vehicles that require long service life and continuous high power capabilities.

### SUMMARY OF THE INVENTION

The present invention is a sealing system for a Lithium-ion battery, having at least one Lithium-ion cell with at least one anode, at least one cathode, an anode current collecting tab connected to the at least one anode, a cathode current collecting tab connected to the at least one cathode, and an electrolyte. The sealing system further has an external case for containing the at least one Lithium-ion cell and a case lid having current collecting poles. The case lid is hermetically sealed to the external case. The sealing system still further has; an initial enclosure of plastic for enclosing each Lithium-ion cell, the initial enclosure hermetically seals each Lithium-ion cell, with the current collecting tabs extending through the initial enclosure.

### BRIEF DESCRIPTION OF THE DRAWINGS

FIG. 1(a) is a perspective view of a Lithium-ion cell having current collecting tabs connected to stacked foils of the electrodes;

FIGS. 1(b) and 1(c) are perspective view and a top view, respectively, of an initial enclosure of the invention having current collecting tabs of a prismatic cell extending through the initial enclosure, with enclosure-to-metal hermetic seals along the length of the current collecting tabs;

FIG. 1(d) is a perspective view of an initial enclosure of the invention having current collecting tabs of a cylindrical cell extending through the initial enclosure, with enclosure-to-metal hermetic seals around the current collecting tabs.

FIG. 1(e) is a perspective view of the embodiment shown in FIG. 1(c) further having the current collecting tabs connected to common current collectors and current collecting poles positioned in a case lid of an external case of a Lithium-ion battery;

FIG. 1(f) is a perspective view of the embodiment shown in FIG. 1(e) further having the case lid hermetically sealed to the external case of the Lithium-ion battery;

FIG. 2(a) is a perspective view of two hermetically sealed initial enclosures of the invention of the type shown in FIG. 1(c), further having the current collecting tabs of the two cells that are in the initial enclosure connected to common current collectors, so as to have the cells connected in parallel;

FIG. 2(b) is a perspective view of the embodiment shown in FIG. 2(a) further having a secondary enclosure enclosing the two initial enclosures, enclosure-to-metal hermetic seals are around the common current collectors;

FIG. 2(c) is a perspective view of the embodiment shown in FIG. 2(b), further having the common current collectors connected to current collecting poles of a case lid, and the case lid hermetically sealed to an external case of the battery;

FIG. 3(a) is a perspective view of five hermetically sealed initial enclosures of the invention, of the type shown in FIG. 1(c), further having current collecting tabs of the five cells connected to common current collectors, so as to have the cells connected in parallel;

FIG. 3(b) is a perspective view of the embodiment shown in FIG. 3(a) further having a secondary enclosure enclosing the five initial enclosures, a hermetic seal of the secondary enclosure is to a case lid and the common current collectors are connected to current collecting poles of the case lid; and

FIG. 3(c) is a perspective view of the embodiment shown in FIG. 3(b), further having the case lid hermetically sealed to an external case of the battery.

### DETAILED DESCRIPTION

A multiple hermetic sealing of the invention provides a battery manufacturing process more adaptable to mass production, because electrolyte filling is conducted easily in an enclosure before an initial hermetic sealing. Degassing is conducted on the cell following a first time charging and prior to the initial hermetic sealing. After the initial hermetic sealing, individually sealed cells can be connected in series or parallel to form a cell set. The cell set is then subjected to an external case hermetic sealing with a rigid steel or aluminum external case preferably with a safety vent. The rigid external case is preferred to be steel or aluminum but it is not limited to such and can be any other material. The important feature of this present invention is to make the initial sealing and the external case sealing both hermetic in order to decrease the possibility of any electrolyte contact with the external case. It should be noted that the cell set as placed in the rigid case, as aforementioned, can be a single cell as well, that is one cylindrical cell or one prismatic cell. The initial sealing is not limited to any form or any method, although it must be hermetic. The advantages of the double hermetic sealing structure are as follows:
1. Prevention of leakage of electrolyte owing to the presence of at least two layers of protection with two hermetic sealings.
2. There is no need to use copper as the negative pole (i.e. current collector for the final battery) owing to the avoidance of direct contact of the current collecting pole with the electrolyte. Because of the presence of the initial hermetic sealing, the negative current collecting pole can be aluminum or any other less costly materials, rather than copper that is conventionally used as the negative pole for the prevention of corrosion when electrolyte is in direct contact with the pole.
3. The bags used for the first hermetic sealing can be any form of plastic thin film rather than laminated aluminum foils or other metallic foils.
4. The need for filling electrolyte into the battery after sealing the rigid case is eliminated. This is achievable because the electrolyte addition is conducted prior to initial hermetic sealing. Also, the initial enclosure limits the space requiring electrolyte, thus the amount of electrolyte addition can be minimized.
5. No gas pressure is built up in the final battery since degassing is performed before the initial hermetic sealing is conducted.
6. The multiple hermetic sealing structure allows gluing of cells, already subjected to the initial hermetic sealing, to attach the cells to the external case that will be subjected to the external case hermetic sealing. Stabilization by gluing or the like, can prevent possible damage of electrode stacks if the final battery is subjected to vibration or other forces.
7. Production yield of the final battery can be increased if cells already subjected to the initial hermetic sealing can be examined and tested individually before they are grouped together and placed inside the external case, and subjected to the external case hermetic sealing.

In addition to a battery having cells with an initial hermetic sealing and the external case hermetic sealing, another embodiment of the present invention provides a second hermetically sealed enclosure, referred to as a secondary enclosure. The secondary enclosure is utilized in containing the cell set consisting of the individual cells. The individual cells are first subjected to the initial hermetic sealing. With this secondary hermetic sealing, outside the cell set, which is already hermetically sealed, the chance of electrolyte penetration is very small. Eventually, the cell set being sealed by the secondary hermetic sealing is again sealed with the external case hermetic seal. Again, the external case can be steel or aluminum with a safety vent but it is not limited to such. In regard to cost consideration, because of the initial and secondary hermetic sealing, the requirements for the hermetic sealing of the external case can be less stringent.

Also, a tertiary hermetic sealing is possible with use of a tertiary enclosure in a manner like the secondary enclosure.

Materials that can be utilized for the initial, secondary and tertiary hermetic sealings include plastic, or plastic composite film. The plastic composite film can be formed with layers, including Polyethylene (PE), Polypropylene (PP), Polyurethane (PU), Nylon, Polyethylene terephthalate (PET), Acrylonitrile butadiene styrene (ABS), Fluorinated ethylene propylene (FEP), Polyoxymethylene (Delrin), Polyimide, Polyacrylic, and Epoxy resin or a combination of the listed materials.

Hermetic sealing of the external case is preferably conducted on a rigid external case with a safety vent. The materials that can be utilized as the external case are preferably steel or aluminum but other kinds of rigid cases, can be used in carrying out the present invention. Although rigid cases are preferred as the external protection, laminated aluminum foil or similar materials can be used as the external case for the external case hermetic sealing. This is because with the present invention the external case protection with the external case hermetic sealing being conducted prevents the leakage of electrolyte, gas, and water molecules, even though the external case is not a rigid case.

The present invention is disclosed with use of the following examples.

### Example I

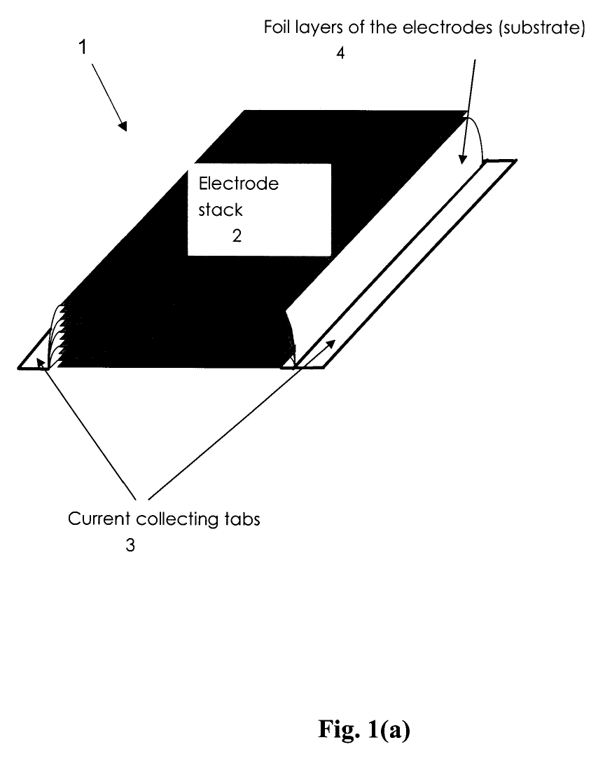

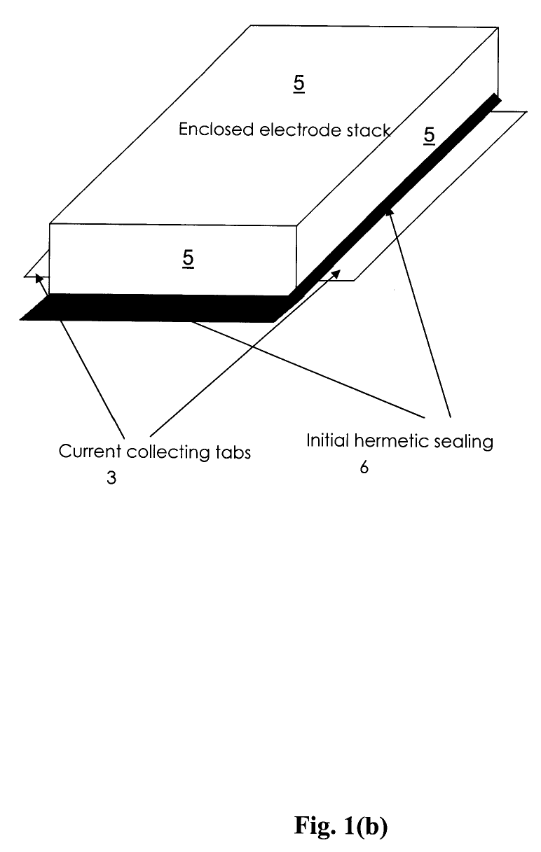

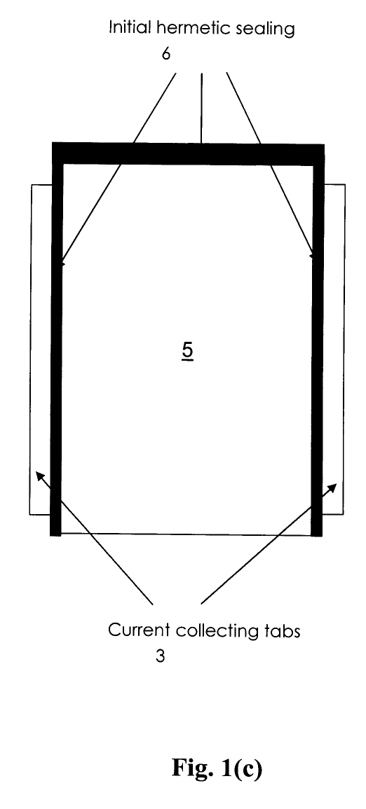

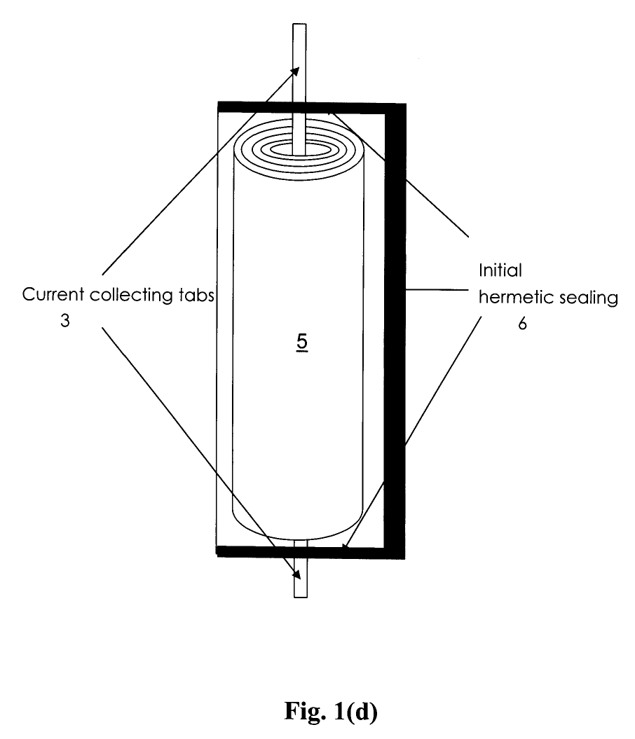

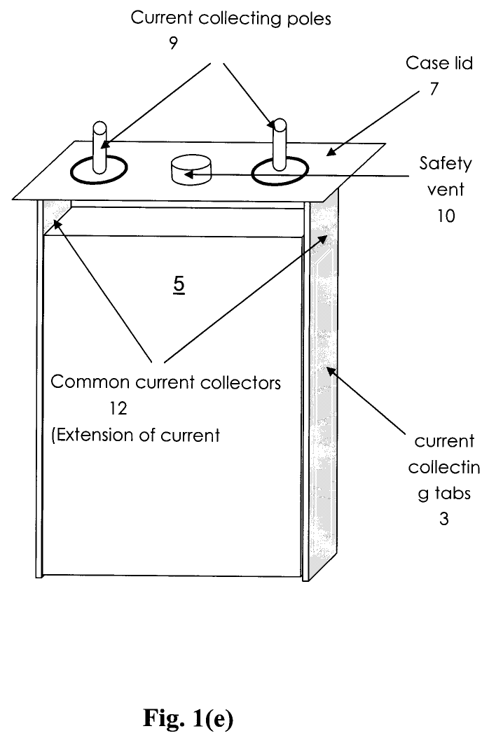

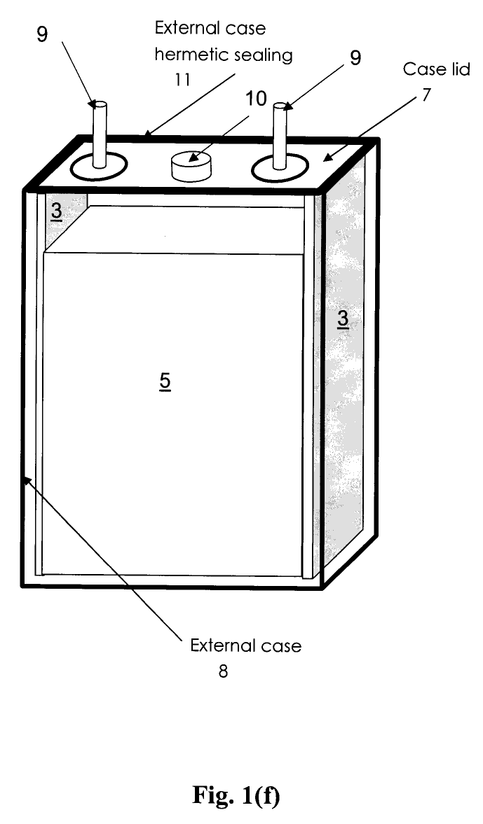

FIG. 1(a) shows a cell 1 having a 15 Ah electrode stack 2 with current collecting tabs 3 attached to the foil layers 4 of the electrodes. After the electrode stack and current collecting tabs are connected, such as by spot welding or riveting foil layers of the electrode stack to the current collecting tabs, an initial plastic enclosure 5, as shown in FIGS. 1(b), 1(c) and 1(d), is used for enclosing the electrode stack having the current collecting tabs. Then the proper amount of electrolyte is added into the initial enclosure 5. A pre-sealing step is then conducted on the initial enclosure and the cell is ready for a first time charging, which is then conducted. After a degassing process (i.e. a process utilized for eliminating gas evolved during the first time charging), hermetic sealing of the initial enclosure is conducted on the cell to form the hermetically sealed cell as shown in FIGS. 1(b), 1(c) and 1(d). The initial enclosure is sealed to the current collecting tabs and other openings such as the sides as shown at 6. The sealing can be a heat seal, an adhesive seal, or any other suitable seal that provides a hermetic seal. The cell is then connected to a case lid 7 as shown in FIG. 1(e). The case lid is a pre-constructed component with positive and negative current collecting poles 9, and a safety vent 10. The case lid is not permeable to molecular species such as water or gas molecules. The hermetically sealed cell connected to the case lid is then inserted into the external case. The external case hermetic sealing is then conducted between the external case 8, having the hermetically sealed cell-inside, and the case lid, as shown in FIG. 1(f) at 11. It should be noted that both seals are designated to be hermetically sealed. The initial enclosure 5 can be in the form of a plastic bag, with the current collecting tabs 3 extending through the initial enclosure. An enclosure-to-metal seal 6 is shown in FIGS. 1(b) and 1(c) in which the hermetic seal 6 is along the length of each current collecting tab 3. Example I is described with a prismatic cell. A cylindrical cell can also be used, with the initial hermetic seal 6 being as shown in FIG. 1(d) and the current collecting tabs 3 connected to the current collecting poles (not shown).

Materials that can be utilized for the initial hermetic sealing include plastic, or plastic composite film. The plastic composite film can be formed with layers, including Polyethylene (PE), Polypropylene (PP), Polyurethane (PU), Nylon, Polyethylene terephthalate (PET), Acrylonitrile butadiene styrene (ABS), Fluorinated ethylene propylene (FEP), Polyoxymethylene (Delrin), Polyimide, Polyacrylic, and Epoxy resin or a combination of the listed materials.

### Example II

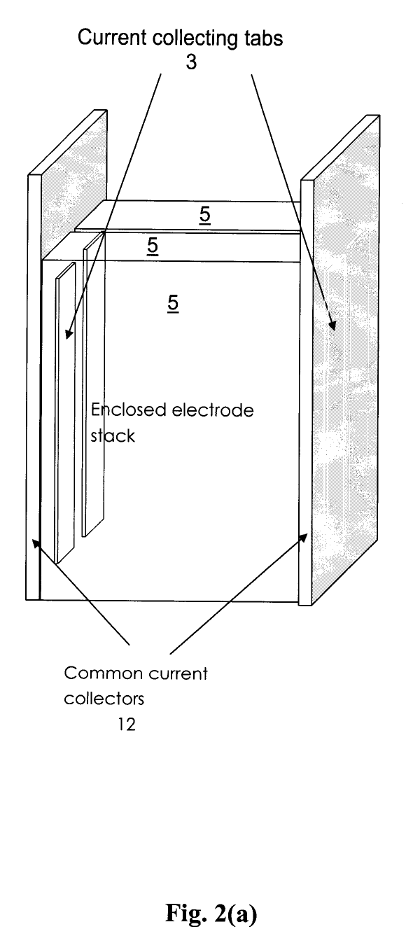

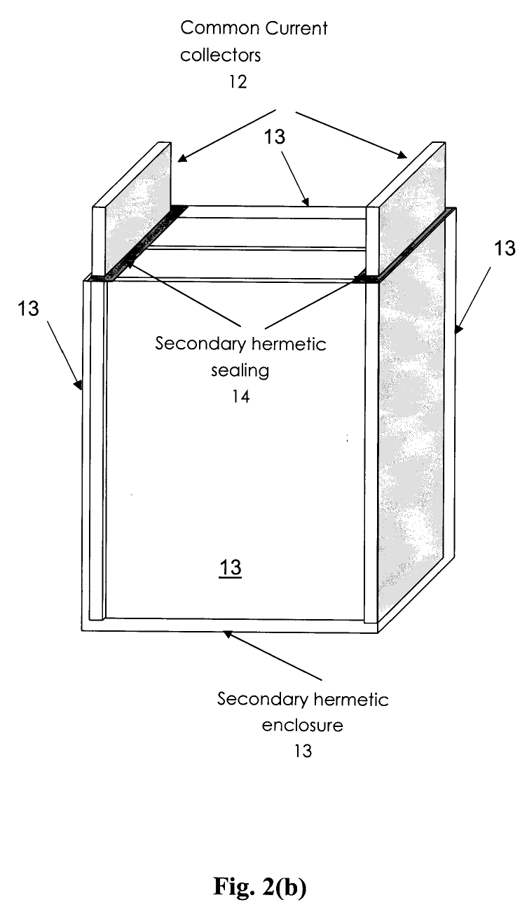

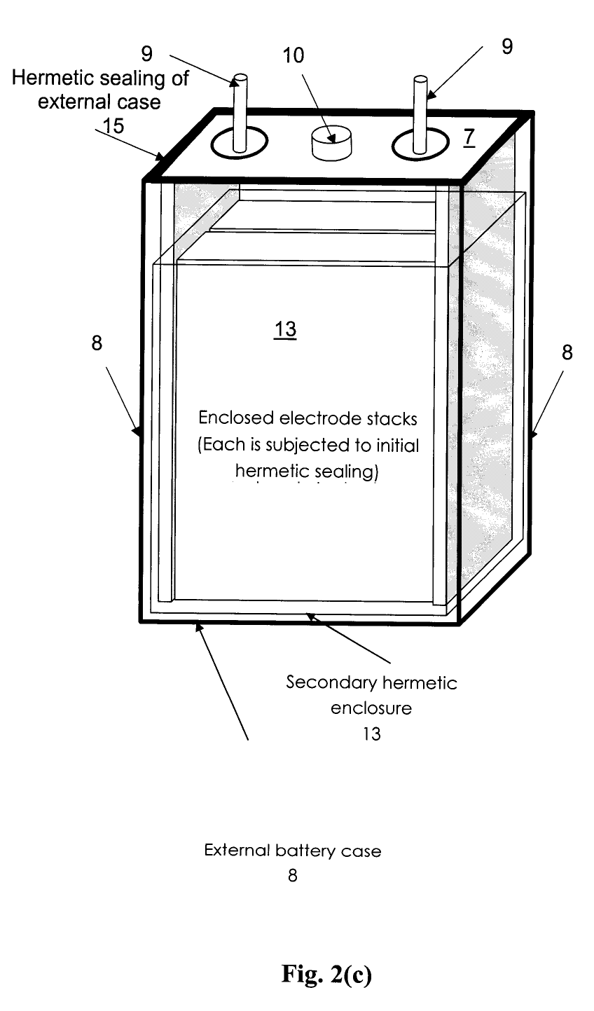

Two 15 Ah cells that each have the initial hermetic sealing in the initial enclosure 5 (each of them being as shown in FIG. 1(b)) are first connected to and stabilized on common current collectors 12 (one for positive and the other for negative) as shown in FIG. 2(a), as a cell set. The cell set can be two or more cells. A secondary hermetic sealing in a secondary enclosure 13 is then carried out on the cell set, as shown in FIG. 2(b). Seal 14 seals the secondary enclosure to the common current collectors 12. The secondary hermetically sealed cell set is then connected to the case lid 7 of the external case 8 (similar to FIG. 1(e)). The sealed cell set having the initial enclosure 5 and the secondary enclosure 13, along with the case lid 7 are then inserted into the external case 8. Then, the external case hermetic sealing 15 is carried out between the exterior case and the case lid, as shown in FIG. 2(c). In this example, the electrolyte and gas molecules are contained by three layers of materials with three hermetic seals. They are: the exterior case 8 including the case lid 7, the secondary hermetically sealed enclosure 13, and the initial hermetically sealed enclosure 5. It should be noted that all layers of materials are designated to be hermetically sealed. In this embodiment the hermetic seal of the initial enclosure 5 should be as shown in FIG. 1(b) in order that the length of the current collecting tabs 3 are outside of the initial enclosure 5 for connecting to the common current collectors 12 (shown in FIG. 2(a).

Materials that can be utilized for the initial hermetic sealing include plastic, or plastic composite film. The plastic composite film can be formed with layers, including Polyethylene (PE), Polypropylene (PP), Polyurethane (PU), Nylon, Polyethylene terephthalate (PET), Acrylonitrile butadiene styrene (ABS), Fluorinated ethylene propylene (FEP), Polyoxymethylene (Delrin), Polyimide, Polyacrylic, and Epoxy resin or a combination of the listed materials.

### Example III

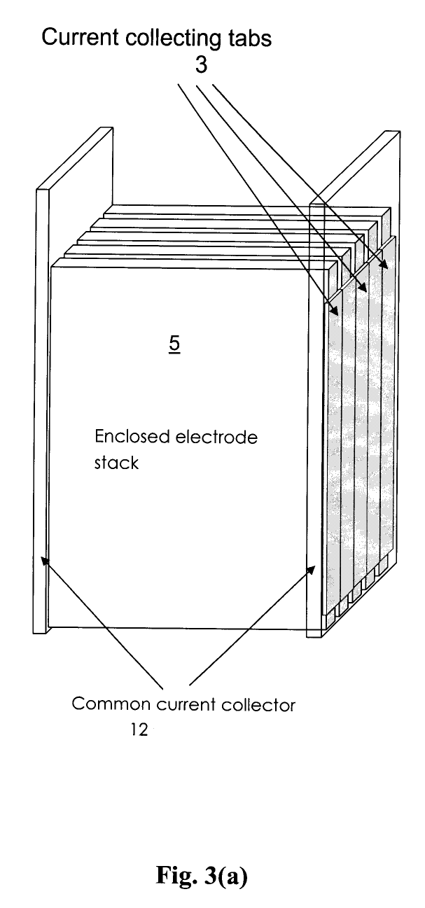

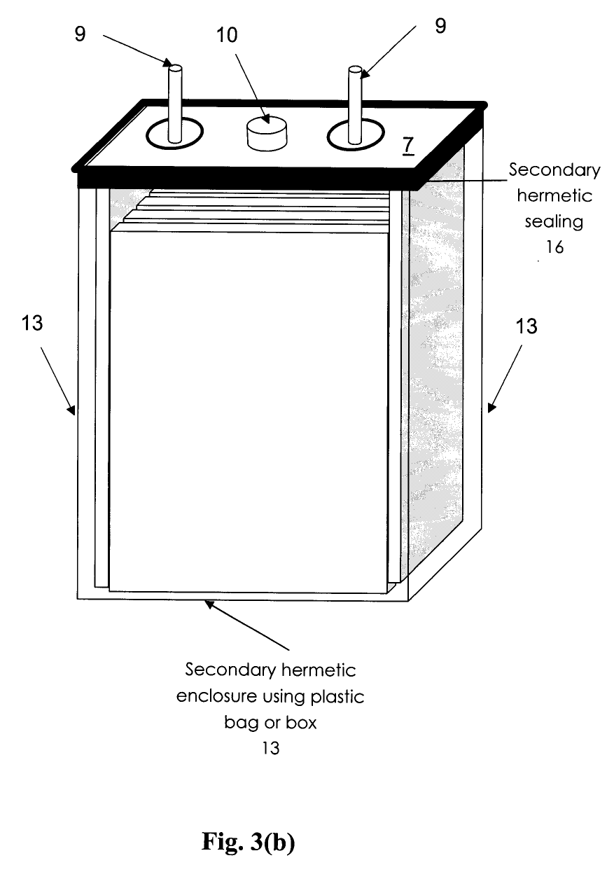

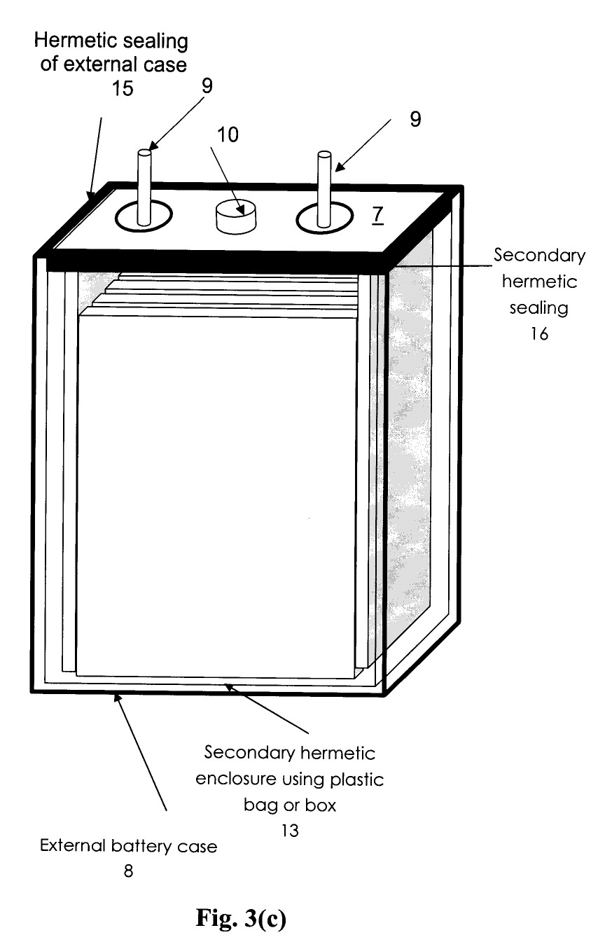

Five 10 Ah cells that each have the initial hermetic sealing 5 (each of them being as shown in FIG. 1(b)) are first connected to and stabilized on a common current collectors 12 (one for positive and the other for negative) as shown in FIG. 3(a) as a cell set. The cell set can be two or more cells. A plastic material, preferably in the shape of a bag or box, with one end open, is then used as a secondary enclosure 13 for enclosing the previously prepared cell set. A secondary hermetic sealing is then carried out between the top of the plastic bag or box 13 and the case lid 7 as shown at 16 in FIG. 3(b). Finally, an external case sealing is carried out between an external case and the case lid as shown at 15 in FIG. 3(c). In this example, two layers of hermetically sealed protection are provided through the lid 7 to the electrode stacks 2 (the hermetic seal of the lid/secondary seal layer 13, and the initial hermetically sealed enclosure layer 5) and three layers of hermetically sealed protection are provided through the external case 8 (the external steel case/lid hermetic seal layer at 15, the secondary hermetically sealed plastic bag or box layer 13, and the initial hermetically sealed enclosure layer 5). It should be noted that all layers of material are designated to be hermetically sealed. Since at least two durable layers of material with two hermetic sealing have been provided in this example, the third hermetic sealing 15 of the external case 8 and the lid 7 can be less stringent. A conventional but low cost chime seam sealing method, such as found in canned food, can be utilized for replacing the high cost laser welding typically used for the external case sealing 15. Also, a combination of a chime seam with a filler such as epoxy in the chime seam can be used.

Materials that can be utilized for the initial hermetic sealing include plastic, or plastic composite film. The plastic composite film can be formed with layers, including Polyethylene (PE), Polypropylene (PP), Polyurethane (PU), Nylon, Polyethylene terephthalate (PET), Acrylonitrile butadiene styrene (ABS), Fluorinated ethylene propylene (FEP), Polyoxymethylene (Delrin), Polyimide, Polyacrylic, and Epoxy resin or a combination of the listed materials.

In all of the above examples, because of the avoidance of direct contact of current collecting poles 9 with the electrolyte, due to the presence of the hermetic sealing of the initial enclosure, the negative current collecting pole can be aluminum, rather than copper that is conventionally used for the negative pole.

What is claimed is:

1: A sealing system for a Lithium-ion battery, comprising
at least one Lithium-ion cell having at least one anode, at least one cathode, an anode current collecting tab connected to the at least one anode, a cathode current collecting tab connected to the at least one cathode, and an electrolyte;
an external case for containing said at least one Lithium-ion cell;
a case lid having current collecting poles, said case lid being hermetically sealed to said external case; and
an initial enclosure of plastic for enclosing each Lithium-ion cell, said initial enclosure hermetically sealing each Lithium-ion cell, with said current collecting tabs extending through said initial enclosure.

2: The sealing system for a Lithium-ion battery of claim 1, further comprising
a plurality of Lithium-ion cells each having said initial enclosure;
an anode common current collector connected to all of said anode current collecting tabs;
a cathode common current collector connected to all of said cathode current collecting tabs; and
a secondary enclosure of plastic hermetically sealing all of said plurality of Lithium-ion cells having said initial enclosure, with said common current collectors extending through said secondary enclosure.

3: (The sealing system for a Lithium-ion battery of claim 1, further comprising
a plurality of Lithium-ion cells each having said initial enclosure;
an anode common current collector connected to all of said anode current collecting tabs;
a cathode common current collector connected to all of said cathode current collecting tabs; and
a secondary enclosure of plastic hermetically sealing all of said plurality of Lithium-ion cells having said initial enclosure, with a hermetic seal of said secondary enclosure being made to said case lid.

4: The sealing system for a Lithium-ion battery of claim 1, 2 or 3, wherein
each enclosure of plastic is formed of a film of Polyethylene (PE), Polypropylene (PP), Polyurethane (PU), Nylon, Polyethylene terephthalate (PET), Acrylonitrile butadiene styrene (ABS), Fluorinated ethylene propylene (FEP), Polyoxymethylene (Delrin), Polyimide, Polyacrylic, Epoxy resin or a combination of the above.

5: The sealing system for a Lithium-ion battery of claim 1, wherein
said initial enclosure of plastic is hermetically sealed at said current collecting tabs by heat sealing or with an adhesive.

6: The sealing system for a Lithium-ion battery of claim 2, wherein
said initial enclosure of plastic is hermetically sealed at said current collecting tabs by heat sealing or with an adhesive; and
said secondary enclosure of plastic is hermetically sealed at said common current collectors by heat sealing or with an adhesive.

7: The sealing system for a Lithium-ion battery of claim 3, wherein
said initial enclosure of plastic is hermetically sealed at said current collecting tabs by heat sealing or with an adhesive; and
said secondary enclosure of plastic is hermetically sealed at said case lid by heat sealing or with an adhesive.

8: The sealing system for a Lithium-ion battery of claim 2, further comprising
a tertiary enclosure of plastic hermetically enclosing said secondary enclosure, with said common current collectors extending through said tertiary enclosure.

9: The sealing system for a Lithium-ion battery of claim 3, further comprising
a tertiary enclosure of plastic hermetically enclosing said plurality of lithium-ion cells having said initial enclosure, with said common current collectors extending through said tertiary enclosure, said tertiary enclosure being hermetically sealed inside said secondary enclosure.

10: The sealing system for a Lithium-ion battery of claim 1, further comprising
a plurality of Lithium-ion cells each having said initial enclosure, wherein said plurality of Lithium-ion cells having said initial enclosure are connected in series.

11: The sealing system for a Lithium-ion battery of claim 1, wherein
said case lid is hermetically sealed to said external case by laser welding, use of a chime seam, or use of a chime seam in combination with a filler provided in the chime seam.

12: The sealing system for a Lithium-ion battery of claim 1, wherein
said current collecting poles include a positive and a negative current collecting pole, and said negative current collecting pole is of Aluminum.

13: A method for sealing a Lithium-ion battery, comprising
providing at least one Lithium-ion cell having at least one anode, at least one cathode, an anode current collecting tab connected to the at least one anode, a cathode current collecting tab connected to the at least one cathode, and an electrolyte;
providing an external case for containing said at least one Lithium-ion cell;
providing a case lid having current collecting poles;
hermetically sealing each Lithium-ion cell in an initial enclosure of plastic, with said current collecting tabs extending out of each initial enclosure; and
placing said at least one Lithium-ion cell having said initial enclosure of plastic in said external case and hermetically sealing said case lid to said external case.

14: The method for sealing a Lithium-ion battery of claim 13, further comprising
providing a plurality of Lithium-ion cells each having said initial enclosure;
providing an anode common current collector connected to all of said anode current collecting tabs;
providing a cathode common current collector connected to all of said cathode current collecting tabs;
prior to placing said at least one Lithium-ion cell having said initial enclosure in said external case, hermetically sealing all of said plurality of lithium-ion cells having said initial enclosure in a secondary enclosure of plastic, with said common current collectors extending out of said secondary enclosure.

15. The method for sealing a Lithium-ion battery of claim 13, further comprising
providing a plurality of Lithium-ion cells each having said initial enclosure;
providing an anode common current collector connected to all of said anode current collecting tabs;
providing a cathode common current collector connected to all of said cathode current collecting tabs;
prior to placing said at least one Lithium-ion cell having said initial enclosure in said external case, hermetically sealing all of said plurality of lithium-ion cells having said initial enclosure in a secondary enclosure of plastic, with a hermetic seal of said secondary enclosure being made to said case lid.

16: The method for sealing a Lithium-ion battery of claim 13, 14 or 15, wherein
each enclosure of plastic is formed of a film of Polyethylene (PE), Polypropylene (PP), Polyurethane (PU), Nylon, Polyethylene terephthalate (PET), Acrylonitrile butadiene styrene (ABS), Fluorinated ethylene propylene (FEP), Polyoxymethylene (Delrin), Polyimide, Polyacrylic, Epoxy resin or a combination of the above.

17: The method for sealing a Lithium-ion battery of claim 13, wherein
said initial enclosure of plastic is hermetically sealed at said current collecting tabs by heat sealing or with an adhesive.

18: The method for sealing a Lithium-ion battery of claim 14, wherein
said initial enclosure of plastic is hermetically sealed at said current collecting tabs by heat sealing or with an adhesive; and
said secondary enclosure of plastic is hermetically sealed at said common current collectors by heat sealing or with an adhesive.

19: The method for sealing a Lithium-ion battery of claim 15, wherein
said initial enclosure of plastic is hermetically sealed at said current collecting tabs by heat sealing or with an adhesive; and
said secondary enclosure of plastic is hermetically sealed at said case lid by heat sealing or with an adhesive.

20: The method for sealing a Lithium-ion battery of claim 13, further comprising
providing a plurality of Lithium-ion cells, each having said initial enclosure and connecting said plurality of Lithium-ion cells in series.

21: The method for sealing a Lithium-ion battery of claim 13, wherein
said case lid is hermetically sealed to said external case by laser welding, use of a chime seam, or use of a chime seam in combination with a filler provided in the chime seam.

22: The method for sealing a Lithium-ion battery of claim 13, further comprising, prior to hermetically sealing each Lithium-ion cell in the initial enclosure,
filling said initial enclosure with said electrolyte;
closing said initial enclosure;
providing a first charging to said lithium-ion cell; and
degassing said closed initial enclosure.
